(19) United States
(12) Patent Application Publication
(10) Pub. No.: US 2015/0141578 A1
(43) Pub. Date: May 21, 2015

(54) REINFORCING ELEMENT HAVING POLYESTER LAYERS

(71) Applicants: COMPAGNIE GENERALE DES ETABLISSEMENTS MICHELIN, CLERMONT-FRRAND (FR); Michelin Recherche et Technique S.A., GRANGES-PACCOT (CH)

(72) Inventors: Hélène Decorps, Clermont-Ferrand (FR); David Doisneau, Clermont-Ferrand (FR); Eve-Anne Filiol, Clermont-Ferrand (FR); Lina Henao, Clermont-Ferrand (FR); Jérôme Pulpytel, Paris (FR); Xavier Callies, Paris (FR); Farzaneh Arefi-Khonseri, Paris (FR); Olivier Carton, Paris (FR)

(21) Appl. No.: 14/403,900

(22) PCT Filed: May 24, 2013
(86) PCT No.: PCT/EP2013/060697

§ 371 Date: Nov. 25, 2014

(30) Foreign Application Priority Data
Jun. 1, 2012 (FR) 1255097
Oct. 12, 2012 (FR) 1259755

(51) Int. Cl. B32B 7/02; C08J 5/04; B32B 27/36

(52) U.S. Cl. CPC B32B 7/02; B32B 27/36; C08J 5/046; C08J 2321/00; C08J 2467/02
USPC 525/165; 428/212

(57) ABSTRACT

The reinforcing element (R) comprises a surface layer (C1, C2) having a degree of crystallinity Tc and an atomic percentage of oxygen element Pc and an internal layer (C3) having a degree of crystallinity Ti and an atomic percentage of oxygen element Pi satisfying Ti/Tc≧1.10, Pi/Pc<1. Each surface layer (C1, C2) and internal layer (C3) is made of polyester.

The invention relates to the reinforcing elements of tyres, particularly of tyres for passenger or two-wheeled vehicles or for aircraft.

A tyre having a radial carcass reinforcement comprises a tread, two beads each comprising a bead wire, two sidewalls connecting the beads to the tread and a belt, or crown reinforcement, placed circumferentially between the carcass reinforcement and the tread. The carcass and crown reinforcements may comprise reinforcing elements that comprise textile fibres, for example made of polyester. These textile fibres generally take the form of a folded yarn or else a woven fabric. The fibres are embedded in a rubber matrix in order to form a reinforcing ply.

In the case of a folded yarn, a spun yarn consisting of textile monofilament fibres is overtwisted so as to form an overtwisted yarn. Next, several overtwisted yarns are twisted together to form a folded yarn.

In the case of a woven fabric, several folded yarns are assembled using one or more weft yarns by weaving, so as to form a woven fabric.

A method for the chemical treatment of such folded yarns is known from the prior art.

During this method, the reinforcing element is firstly coated with an adhesion primer. The adhesion primer generally comprises an aqueous solution based on epoxy and isocyanates.

Next, the reinforcing element coated with the adhesion primer is coated with an adhesive, comprising resorcinol, formaldehyde and a latex, also referred to as RFL adhesive.

The adhesion primer makes it possible to improve the quality of the bond between the reinforcing element and the RFL adhesive while the RFL adhesive makes it possible to ensure the adhesion between the reinforcing element and the rubber matrix in the crosslinked state.

This method therefore comprises two chemical steps of coating the reinforcing element, which makes it relatively tedious and expensive.

Moreover, the use of epoxy and/or isocyanate requires certain expensive environmental and toxicological safety measures to be taken. Indeed, it is common for impurities to be present in the bath comprising the adhesion primer, especially epichlorohydrin, products from which it is necessary to be protected or else that it is necessary to remove in an appropriate manner.

The objective of the present invention is a reinforcing element without adhesion primer.

For this purpose, one subject of the invention is a reinforcing element comprising a surface layer having a degree of crystallinity Tc and an atomic percentage of oxygen element Pc and an internal layer having a degree of crystallinity Ti and an atomic percentage of oxygen element Pi satisfying Ti/Tc≧1.10, Pi/Pc<1, each surface layer and internal layer being made of polyester.

The surface layer of the reinforcing element has physical and chemical properties that make it possible to obtain an excellent adhesion between the rubber matrix and the reinforcing element while avoiding the use of an adhesion primer.

The surface layer denotes a portion of the material of the reinforcing element located below the outer surface of the polyester. The thickness of the surface layer is measured from the external surface of the polyester.

The surface layer has a relatively high polarity, i.e. an atomic percentage of oxygen element greater than that of the internal layer. Thus, the surface layer is relatively hydrophilic which improves the wettability and the diffusion of the adhesive into the reinforcing element. Furthermore, the surface layer is capable of bearing polar groups that can react chemically with the adhesive.

The surface layer has a relatively low degree of crystallinity. Thus, since the surface layer is relatively unorganised, it allows a better diffusion of the adhesive into the reinforcing element.

The layered structure of the reinforcing element according to the invention makes it possible to separate the functions of each surface and internal layer. Thus, the surface layer has an adhesion function while the internal layer has a reinforcing function owing to its intrinsic mechanical properties.

The polyester is generally semicrystalline and therefore comprises, on the one hand, crystalline regions and, on the other hand, amorphous regions.

The expression “layer made of polyester” is understood to mean that each layer comprises at least 50% by weight of polyester, preferably 75% and more preferably 90%. Each layer made of polyester may thus comprise, in addition to the polyester, additives, especially at the moment when the latter is formed, it being possible for these additives to be, for example, agents for protecting against ageing, plasticizers, fillers such as silica, clays, talc or kaolin, depending on the specific nature of the reinforcing element.

Advantageously, Ti/Tc≧1.20, preferably Ti/Tc≧1.45, more preferably Ti/Tc≧1.60 and more preferably still Ti/Tc≧1.80.

Advantageously, Pi/Pc≦0.95, preferably Pi/Pc≦0.85 et more preferably Pi/Pc≦0.75.

Thus, by reducing the degree of crystallinity of the surface layer, and by increasing its atomic percentage of oxygen element, the adhesion between the reinforcing element and the rubber matrix is further promoted.

In one embodiment, the thickness of the surface layer is greater than or equal to 0.5 μm. Advantageously, the thickness is less than or equal to 10 μm, preferably less than or equal to 5 μm, and more preferably less than or equal to 1 μm.

In another embodiment, the thickness is preferably greater than or equal to 1 μm. Advantageously, the thickness is less than or equal to 10 μm, preferably less than or equal to 5 μm.

In yet another embodiment, the thickness is greater than or equal to 5 μm.

Advantageously, the thickness is less than or equal to 10 μm.

According to other preferred characteristics of the surface layer:

Tc≦30%, preferably Tc≦25% and more preferably Tc≦21%.

Pc≦27%, preferably Pc≦30% and more preferably Pc≦32%.

Such values enable excellent adhesion of the reinforcing element to the rubber matrix.

According to other preferred characteristics of the internal layer:

Ti≦50%, preferably Ti≦45% and more preferably Ti≦40%.

Pi≦27%, preferably Pi≦26% and more preferably Pi≦25%.

The lower the degree of crystallinity of the internal layer, the easier it is to obtain a surface layer having a low degree of crystallinity, by virtue of suitable treatment methods, for example using a plasma torch treatment method.

Similarly, the higher the atomic percentage of oxygen element of the internal layer, the easier it is to obtain a surface layer having a high atomic percentage of oxygen element, by virtue of suitable treatment methods, for example using a plasma torch treatment method.

In one embodiment, the reinforcing element is a monofilament or elementary filament. Each monofilament has, preferably, a diameter less than or equal to 30 μm.

In one embodiment, the reinforcing element comprises one or more multifilament fibres.

A multifilament fibre consists of several monofilaments or elementary filaments that are optionally intermingled with one another. Each fibre comprises between 50 and 2000 monofilaments.

In one variant, the reinforcing element comprises one or more folded yarns of multifilament fibres. The folded yarn is obtained by twisting several overtwisted yarns, each overtwisted yarn having been obtained by overtwisting a multifilament fibre.

In another variant, the reinforcing element comprises an overtwisted yarn of a multifilament fibre.

In one embodiment, the reinforcing element comprises a woven fabric of fibres. Such a woven fabric comprises, preferably, several folded yarns of fibres assembled together by weaving using one or more weft yarns. As a variant, the woven fabric of fibres comprises two layers of fibres, the fibres of each layer extending along different directions from one layer to the next.

In another embodiment, the reinforcing element comprises a film. A film denotes in particular any thin layer, for which the ratio of the thickness to the smallest of the other dimensions is less than 0.1. Preferably, the thickness of the film is between 0.05 and 1 mm, more preferably between 0.1 and 0.7 mm. For example, film thicknesses from 0.20 to 0.60 mm have proved perfectly satisfactory for most uses.

In one embodiment, the multifilament fibre, the woven fabric of fibres, the film or the monofilament is entirely made of a material selected from polyethylene terephthalate and polyethylene naphthalate, and preferably is entirely made of polyethylene terephthalate.

In another embodiment, the multifilament fibre, the woven fabric of fibres, the film or the monofilament comprises a first portion made of polyester and a second portion made of a material different from that of the first portion.

The expression “different material” is understood to mean a material that is not identical to that of the first portion. Thus, for example, a polyester of a different nature, in particular having a degree of crystallinity different from that of the first portion, is a different material.

Preferably, the material of the first portion is selected from polyethylene terephthalate and polyethylene naphthalate, and preferably is polyethylene terephthalate.

Preferably, the material of the second portion is selected from a polyester, for example polyethylene terephthalate (PET), polyethylene naphthalate (PEN), polybutylene terephthalate (PBT), polybutylene naphthalate (PBN), polypropylene terephthalate (PPT) or polypropylene naphthalate (PPN), a polyamide, for example an aromatic polyamide, a polyketone, a cellulose or a mixture of these materials.

Optionally, the reinforcing element comprises a layer of adhesive that directly coats the surface layer.

The adhesive enables the adhesion of the reinforcing element to the rubber matrix. The term “directly” is understood to mean that no layer is inserted between the surface layer and the layer of adhesive. In particular, the reinforcing element comprises no layer of adhesion primer, in particular a primer comprising an epoxy resin.

Preferably, the adhesive is of thermosetting type. As a variant, other types of adhesives may be used, for example thermoplastic adhesives.

Among the thermosetting adhesives, mention will be made of those comprising at least one phenol, for example resorcinol, and at least one aldehyde, for example formaldehyde.

Preferably, the adhesive comprises at least one diene elastomer. Such an elastomer makes it possible to improve the tack in the green state and/or in the cured state of the adhesive with the rubber matrix.

Advantageously, the diene elastomer is selected from natural rubber, a styrene/butadiene copolymer, a vinylpyridine/styrene/butadiene terpolymer and a mixture of these diene elastomers.

Other types of adhesive may be used in order to make the reinforcing element adhere to the rubber matrix.

Another subject of the invention is a reinforcing ply comprising at least one reinforcing element as defined above, embedded in a rubber matrix.

The rubber matrix comprises at least a diene elastomer, a reinforcing filler, a vulcanization system and various additives.

The “diene elastomer” of the rubber matrix is generally understood to mean an elastomer resulting at least in part (i.e. a homopolymer or a copolymer) from diene monomers (monomers bearing two carbon-carbon double bonds which may or may not be conjugated).

Particularly preferably, the diene elastomer of the rubber matrix is selected from the group of (essentially unsaturated) diene elastomers consisting of polybutadienes (BRs), synthetic polyisoprenes (IRs), natural rubber (NR), butadiene copolymers, isoprene copolymers and mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and mixtures of such copolymers.

The rubber matrix may contain a single diene elastomer or a mixture of several diene elastomers, it being possible for the diene elastomer(s) to be used in combination with any type of synthetic elastomer other than a diene elastomer, or even with polymers other than elastomers, for example thermoplastic polymers.

As reinforcing filler, use is preferably made of carbon black or an inorganic filler. More particularly, all carbon blacks, especially blacks of the HAF, ISAF or SAF type, conventionally used in tyres are suitable as carbon blacks. As non-limiting examples of such blacks, mention may be made of the N115, N134, N234, N330, N339, N347 and N375 blacks. However, the carbon black may of course be used as a blend with reinforcing fillers and in particular other inorganic fillers. Such inorganic fillers comprise silica, especially highly dispersible silicas, for example the Ultrasil 7000 and Ultrasil 7005 silicas from Degussa.

As other examples of inorganic filler that can be used in the rubber matrix, mention may also be made of aluminium (oxide)hydroxides, aluminosilicates, titanium oxides, and silicon carbides or nitrides, all of reinforcing type as described in documents WO 99/28376 (or U.S. Pat. No. 6,610,261), WO 00/73372 (or U.S. Pat. No. 6,747,087), WO 02/053634 (or US 2004/0030017), WO 2004/003067 and WO 2004/056915.

Finally, a person skilled in the art will understand that, as filler equivalent to the reinforcing inorganic filler described in the present section, a reinforcing filler of another nature, in particular organic nature, could be used, provided that this reinforcing filler is covered with an inorganic layer, such as silica, or else comprises functional sites, in particular hydroxyl sites, at its surface that require the use of a coupling agent in order to form the bond between the filler and the elastomer.

It is also possible to add to the reinforcing filler, depending on the targeted application, inert (non-reinforcing) fillers, such as clay particles, bentonite, talc, chalk and kaolin, that can be used for example in sidewalls or treads of coloured tyres.

The rubber matrix may also comprise all or some of the standard additives customarily used in the elastomer compositions intended for the manufacture of tyres, such as for example plasticizers or extending oils, whether the latter are aromatic or non-aromatic in nature, pigments, protective agents, such as antiozone waxes, chemical antiozonants, antioxidants, antifatigue agents, reinforcing resins, methylene acceptors (for example phenolic novolac resin) or methylene donors (for example HMT or H3M).

The rubber matrix also comprises a vulcanization system based either on sulphur or on sulphur donors and/or on peroxide and/or on bismaleimides, vulcanization accelerators, vulcanization activators and optionally vulcanization retarders.

Another subject of the invention is a finished rubber article comprising at least one reinforcing element as defined above.

Preferably, the finished article is a tyre.

The invention will be better understood on reading the following description, given solely by way of non-limiting example and with reference to the drawings in which:

FIG. 1 is a cross-sectional view of a finished article, here a tyre, according to the invention;

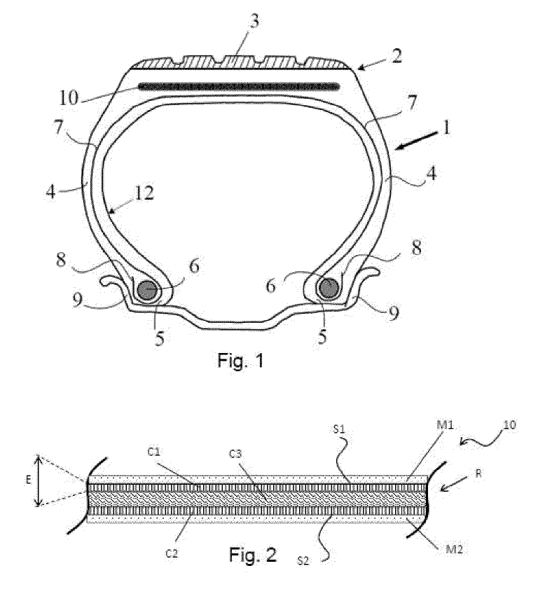

FIG. 2 is a view of details of a longitudinal cross section of a reinforcing ply of the tyre from FIG. 1 comprising a reinforcing element according to the invention;

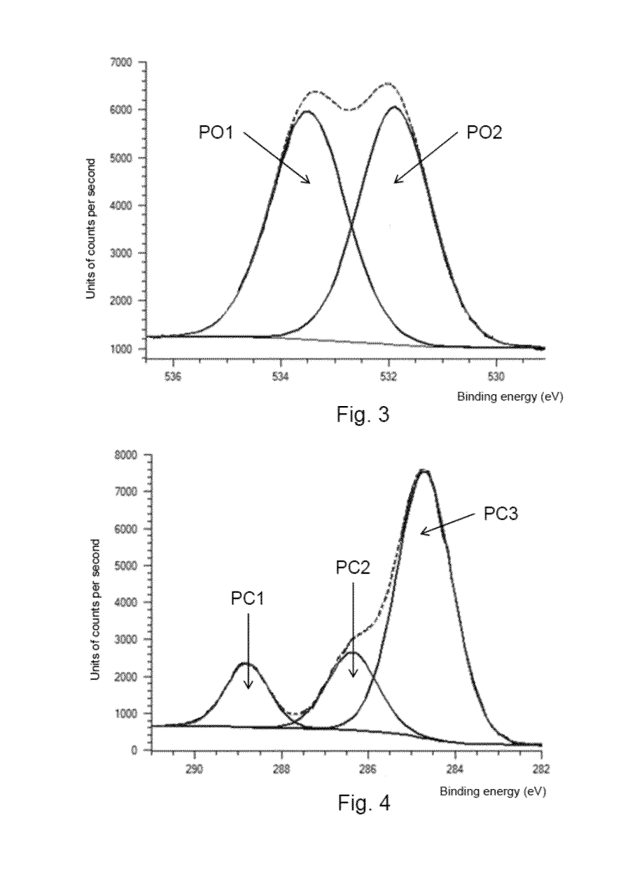

FIG. 3 illustrates an x-ray photoelectron spectrum of a PET material showing the theoretical peaks (as solid line) and measured peaks (as broken line) associated with the oxygen atoms;

FIG. 4 illustrates an x-ray photoelectron spectrum of a PET material showing the theoretical peaks (as solid line) and measured peaks (as broken line) associated with the carbon atoms;

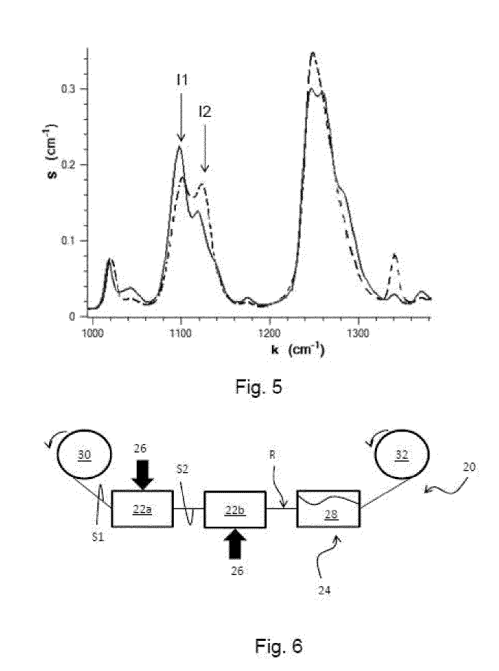

FIG. 5 illustrates an infrared spectrum of a surface layer (as solid line) and of an internal layer (as broken line) of the element from FIG. 2;

FIG. 6 is a diagram of a plant for treating a reinforcing element;

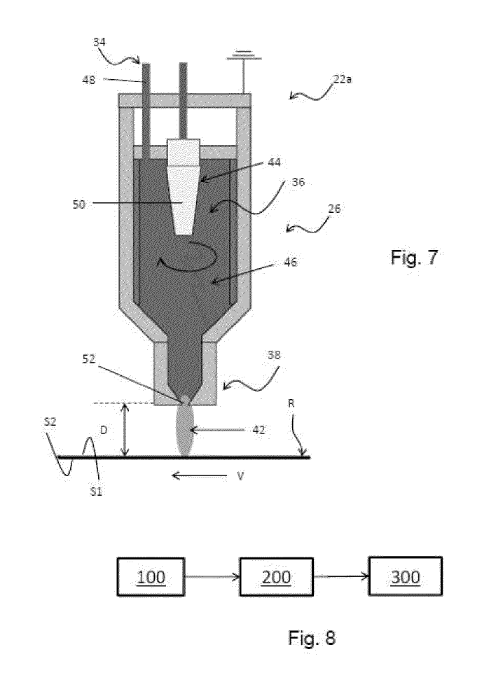

FIG. 7 is a diagram of a device for generating a plasma flow; and

FIG. 8 is a diagram illustrating steps of the treatment method that make it possible to obtain the reinforcing element according to the invention.

Represented in FIG. 1 is a tyre according to the invention and denoted by the general reference 1.

The tyre 1 is intended for motor vehicles of the passenger, 4×4 and SUV (sport utility vehicle) type, but also for two-wheeled vehicles such as motorcycles or bicycles, or for industrial vehicles selected from vans, heavy-duty vehicles (i.e. underground trains, buses, heavy road transport vehicles (lorries, tractors, trailers) and off-road vehicles), agricultural or civil engineering machines, aircraft, and other transport or handling vehicles.

The tyre 1 comprises a crown 2 surmounted by a tread 3, two sidewalls 4 and two beads 5, each of these beads 5 being reinforced with a bead wire 6. A carcass reinforcement 7 is wound around the two bead wires 6 in each bead 5, the turn-up 8 of this reinforcement 7 lying for example towards the outside of the tyre 1, which here is shown fitted onto its rim 9. The crown 2 is here reinforced by a crown reinforcement or belt 10 consisting of at least one reinforcing ply 10. The reinforcing ply 10 is placed radially between the tread 3 and the carcass reinforcement 7.

In the tyre 1 illustrated in FIG. 1, it will be understood that the tread 3, the reinforcing ply 10 and the carcass reinforcement 7 may or may not be in contact with one another, even though these parts have been deliberately separated in the schematic FIG. 1 for reasons of simplification and clarity of the drawing. They could be separated physically, at the very least for a portion of them, for example by tie gums, well known to a person skilled in the art, intended to optimize the cohesion of the assembly after curing.

The reinforcing ply 10 has been represented in FIG. 2.

The reinforcing ply 10 comprises two gum masses M1, M2 forming a rubber matrix between which a reinforcing element R is inserted. The reinforcing element R is thus embedded in the rubber matrix.

The element R is capable of being obtained by the method described below. The element R is textile, that is to say non-metallic. The element R comprises, in this example, a film made entirely of polyester, here made of polyethylene terephthalate (PET) sold under the names “Mylar” and “Melinex” (DuPont Teijin Films), and conforms, preferably, to the film described in document WO 2010/115861. The element R has a thickness equal to 0.35 mm. The element R comprises a layer of adhesive of RFL type (not represented). The layer of RFL adhesive directly coats the element R, that is to say that it is in contact with the element R.

The element made of PET comprises two outer surfaces S1, S2 under each of which a surface layer C1, C2 is positioned. The element R also comprises an internal layer C3 inserted between the surface layers C1, C2. The layer of adhesive directly coats each outer surface S1, S2.

Each surface layer C1, C2 and internal layer C3 is made of PET.

Each surface layer C1, C2 has a thickness E greater than or equal to 0.5 μm.

The thickness E of each surface layer C1, C2 is for example less than or equal to 10 μm, preferably less than or equal to 5 μm and more preferably less than or equal to 1 μm.

In another embodiment, the thickness E of each surface layer C1, C2 is greater than or equal to 1 μm. The thickness E of each surface layer C1, C2 is for example less than or equal to 10 μm, preferably less than or equal to 5 μm.

In yet another embodiment, the thickness E of each surface layer C1, C2 is for example greater than or equal to 1.5 μm. The thickness E of each surface layer C1, C2 is for example less than or equal to 10 μm.

Measurement of the Atomic Percentage of Oxygen Element

The atomic percentage of oxygen element is measured by x-ray photoelectron spectroscopy (XPS).

The atomic percentage of oxygen element of the surface layer is measured directly on the element in accordance with the invention.

The atomic percentage of oxygen element of the internal layer is measured on an element entirely made of a material identical to that of the internal layer. As a variant, the atomic percentage of oxygen element of the internal layer is measured on the element in accordance with the invention, having first removed the surface layer, for example having removed a thickness of material greater than or equal to 5 μm and preferably greater than or equal to 10 μm.

As is known by a person skilled in the art, in a molecule, here PET, since the energy of the electrons of an atom are influenced by its neighbours, it is possible to differentiate various atoms belonging to one and the same element but that are not involved in one and the same chemical function. Thus, the energies corresponding to the various atoms of PET are known from the following documents, and this makes it possible, from XPS spectra, to measure the atomic percentages of the various elements (S. Petit-Boileau. Doctoral thesis of the Université Pierre et Marie Curie (2003); M. Asandulesa, I. Topala, V. Pohoata, N. Dumitrascu. J. Appl. Phys. 108 (2010) 093310; N. K. Cuong, N. Saeki, S. Kataoka, S. Yoshikawa. Hyomen Kagaru (J. of The Surface Science Society of Japan) 23 (2002) 202-208; H. Krump, I. Hudec, M. Jasso, E. Dayss, A. S. Luyt. Applied Surface Science 252 (2006) 4264-4278 and M. Lejeune, F. Brétagnol, G. Ceccone, P. Colpo, F. Rossi. Surface & Coatings Technology 200 (2006) 5902-5907).

Thus, the area of the peaks associated with the two types of oxygen atom of a PET unit (C═O and C—O of the ester function) are measured. These peaks associated with the oxygen atoms are between 530 and 536 eV and illustrated in FIG. 3. The peak PO1 is associated with the oxygen atom of the C—O bond and the peak PO2 is associated with the oxygen atom of the C═O bond.

The area of the peaks associated with the other elements present in the PET is also measured. In particular, the area of the peaks corresponding to the three types of carbon atom of a PET unit (benzene carbons, C═O and carbon from the ester chain) is measured. These peaks associated with the carbon atoms are between 280 and 292 eV and illustrated in FIG. 4. The peak PC1 is associated with the carbon atom of the O═C—O bond, the peak PC2 is associated with the carbon atom of the C—O bond and the peak PC3 is associated with the carbon atoms of the C—C and C—H bonds.

Other elements may be present, for example nitrogen following treatment by a plasma flow in which the gas comprised air or nitrogen. The area of each peak corresponds to the atomic percentage of each atom which is associated therewith.

The atomic percentage of the peaks associated with the oxygen atoms is calculated by taking the ratio of the area of the peaks associated with the oxygen atoms, to the area of the peaks associated with the oxygen and carbon atoms of the spectrum, and where appropriate to the area of the peaks associated with the oxygen, carbon and nitrogen atoms. The areas used for the calculation of the ratio are the Scofield cross sections. The baselines used for the numerical simulation are of Shirley type. After acquisition, the curves are preferably rectified.

The atomic percentage Pc of oxygen element of the surface layer C1, C2 is greater than or equal to 27%, preferably greater than or equal to 30% and more preferably greater than or equal to 32%, and is in this example equal to 35%.

The atomic percentage Pi of oxygen element of the spectrum of the internal layer C3 (or of an element entirely made of a material identical to that of the internal layer) is less than or equal to 27%, preferably less than or equal to 26% and more preferably less than or equal to 25%, and is in this example equal to 25%.

The ratio Pi/Pc of the atomic percentage Pi of oxygen element of the internal layer (or of an element entirely made of a material identical to that of the internal layer), to the atomic percentage Pc of oxygen element of the surface layer, is strictly less than 1, or even less than or equal to 0.95, preferably less than or equal to 0.85 and more preferably less than or equal to 0.75. Specifically, in the case described above, Pi/Pc=25/35=0.71.

Thus, each surface layer C1, C2 has an atomic percentage Pc of oxygen element that is strictly greater than the atomic percentage Pi of oxygen element of the internal layer C3 (or of an element entirely made of a material identical to that of the internal layer).

Measurement of the Degree of Crystallinity

The degree of crystallinity Tc of the surface layer of the reinforcing element is measured by infrared spectroscopy, for example ATR (attenuated total reflectance) infrared spectroscopy, a spectrum of which is illustrated in FIG. 5.

The degree of crystallinity Tc of the surface layer is measured directly on the element in accordance with the invention.

The degree of crystallinity Ti of the internal layer of the reinforcing element is measured by differential enthalpy analysis or else, as a variant, by infrared spectroscopy, for example ATR (attenuated total reflectance) infrared spectroscopy.

The degree of crystallinity Ti of the internal layer is measured on an element entirely made of a material identical to that of the internal layer. As a variant, the degree of crystallinity Ti of the internal layer is measured on the element in accordance with the invention having first removed the surface layer, for example having removed a thickness of material greater than or equal to 5 μm and preferably greater than or equal to 10 μm.

In the case of a measurement by differential enthalpy analysis, the spectrum is acquired according to the standard ASTM D3418. Next, the area A1, A2 respectively of each crystallisation and melting peak is measured. The degree of crystallinity T is given by the relation T=(A2−A1)/(ΔH*·G) in which ΔH* is the specific heat of fusion of the 100% crystalline polyester expressed in J·g⁻¹ and G is the temperature gradient during the differential enthalpy analysis expressed in K·s⁻¹.

In the case of an infrared spectroscopy measurement, use is made of a Bruker Vertex 70-2 Fourier transform spectrometer and a germanium crystal in order to limit the penetration depth of the infrared beam into the sample and to carry out the measurement on an external layer of the reinforcing element, this external layer having a thickness that is less than the thickness of the surface layer.

The maximum intensity I1 of the peak, i.e. the height of the peak with respect to zero, between 1090 and 1110 cm⁻¹ (peak corresponding to the “ester stretching gauche” C═O bond at 1102 cm⁻¹ in theory) is measured, preferably without correction of the spectrum. This peak is characteristic of the amorphous portion of the PET.

The maximum intensity I2 of the peak, that is to say the height of the peak with respect to zero, between 1115 and 1130 cm⁻¹ (peak corresponding to the “ester stretching trans” C═O bond at 1123 cm⁻¹ in theory) is measured, preferably without correction of the spectrum. This peak is characteristic of the crystalline portion of the PET.

The degree of crystallinity Ti, here Ti=38%, of the internal layer C3 (or of an element entirely made of a material identical to that of the internal layer) is furthermore known. Indeed, this can be measured in an absolute manner by differential enthalpy analysis as described above.

The I1/I2 ratio of the spectrum of the layer C3 (or of an element entirely made of a material identical to that of the internal layer) makes it possible to obtain a reference I1/I2 ratio, here I1/I2=107, for the degree of crystallinity Ti=38%. Thus, in order to measure the degree of crystallinity of a sample, the I1/I2 ratio of the sample is measured, in this example I1/I2=57.7, and Tc is calculated from the above reference I1/I2 ratio, this I1/I2 ratio being proportional to the degree of crystallinity of the sample. In this example Tc=38*57.7/107=20% is thus obtained.

Thus, in this example, the degree of crystallinity Tc of the surface layer C1, C2 is less than or equal to 30%, preferably less than or equal to 25% and more preferably less than or equal to 21%, and is equal here to 20%. The degree of crystallinity Ti of the internal layer C3 (or of an element entirely made of a material identical to that of the internal layer) is less than or equal to 50%, preferably less than or equal to 45% and more preferably less than or equal to 40%, and is equal here to 38%.

The Ti/Tc ratio of the degree of crystallinity of the internal layer (or of an element entirely made of a material identical to that of the internal layer) to the degree of crystallinity Tc of the surface layer is greater than or equal to 1.20, preferably greater than or equal to 1.45, more preferably greater than or equal to 1.60 and more preferably still greater than or equal to 1.80. Indeed, in the case described above, Ti/Tc=38/20=1.9.

Thus, each surface layer C1, C2 has a degree of crystallinity Tc and the internal layer C3 (or an element entirely made of a material identical to that of the internal layer) has a degree of crystallinity Ti that satisfies Ti/Tc≧1.10.

Represented in FIG. 6 is a plant for treating the element R that makes it possible to implement a plasma treatment method, especially one using a plasma torch, that enables the reinforcing element according to the invention to be obtained. The plant is denoted by the general reference 20.

The plant 20 comprises two devices 22a, 22b for generating a plasma flow and also a device 24 for coating the reinforcing element R.

A plasma makes it possible to generate, from a gas subjected to a voltage, a heat flux comprising molecules in the gas state, ions and electrons. Advantageously, the plasma is of cold plasma type. Such a plasma, also referred to as non-equilibrium plasma, is such that the temperature originates predominantly from the movement of the electrons. A cold plasma must be distinguished from a hot plasma, also referred to as thermal plasma, in which the electrons and also the ions give this plasma certain properties, especially thermal properties, which are different from those of the cold plasma.

Each device 22a, 22b comprises a plasma torch 26 illustrated in detail in FIG. 7. Each device 22a, 22b is intended to treat respectively each surface S1, S2. The device 24 comprises a bath 28 containing the adhesive, here an adhesive of RFL type.

The adhesive of RFL type is manufactured according to a conventional method known to a person skilled in the art, especially from document DE4439031. The RFL adhesive thus manufactured is stored between 10° C. and 20° C. and must be used within a period of 10 days after its manufacture.

The plant 20 also comprises two upstream and downstream storage rolls respectably denoted by the references 30, 32. The upstream roll 30 carries the untreated reinforcing element R while the roll 32 carries the reinforcing element R that has been plasma-treated by means of the devices 22a, 22b and coated with the adhesive by means of the device 24. The devices 22a, 22b and 24 are arranged in this order between the rolls 30, 32 in the run direction of the reinforcing element R. The devices 22a, 22b are located upstream with respect to the device 24 in the run direction of the reinforcing element R.

Represented in FIG. 7 is the device 22a for generating a plasma flow, here the plasma torch 26 sold by Plasmatreat GmbH. The device 22b is identical to the device 22a. The device 22a is supplied with an alternating current having a voltage of less than 360 V and a frequency of between 15 and 25 kHz.

The device 22a comprises supply means 34 for supplying gas to a chamber 36 for generating the plasma flow and also discharge means 38 for discharging the plasma generated in the chamber 36 in the form of a plasma flow 42, here a plasma jet. The device 22a also comprises means 44 for generating a rotating electric arc 46 in the chamber 36.

The supply means 34 comprise a gas inlet duct 48 for gas to enter the chamber 36. The means 44 for generating the electric arc comprise an electrode 50. The discharge means 38 comprise an outlet orifice 52 for the plasma flow 42.

Represented in FIG. 8 is a diagram illustrating the main steps 100 to 300 of the plasma treatment method that makes it possible to produce the reinforcing element R according to the invention.

During a step 100, the surface S1 is exposed to the flow 42 generated by means of the plasma torch 26. During this step 100, the element R is treated continuously. The treatment method is carried out at atmospheric pressure.

The use of an atmospheric-pressure plasma allows a relatively simple and inexpensive industrial plant to be installed, unlike a method requiring the use of a reduced-pressure plasma combined with the installation of a depressurized chamber.

The flow 42 is obtained from a gas comprising at least one oxidizing component. The expression “oxidizing component” is understood to mean any component capable of increasing the degree of oxidation of the chemical functions present in the polyester.

Advantageously, the oxidizing component is selected from carbon dioxide (CO₂), carbon monoxide (CO), hydrogen sulphide (H₂S), carbon sulphide (CS₂), dioxygen (O₂), nitrogen (N₂), chlorine (Cl₂), ammonia (NH₃) and a mixture of these components. Preferably, the oxidizing component is selected from dioxygen (O₂), nitrogen (N₂) and a mixture of these components. More preferably, the oxidizing component is air.

Here, the flow 42 is obtained from a mixture of air and nitrogen at a flow rate of 2400 L/h.

The orifice 52 is positioned opposite the element R to be treated, here opposite the surface S1. The orifice 52 is located at a constant distance D from the surface S1. For example, this distance is less than or equal to 40 mm, preferably less than or equal to 20 mm and more preferably less than or equal to 10 mm. Preferably, the distance D is greater than or equal to 3 mm.

The element R is made to move, with respect to the plasma flow, at a mean velocity V of less than or equal to 100 metres per minute, preferably less than or equal to 50 metres per minute and more preferably less than or equal to 30 metres per minute. The mean velocity V is equal to the ratio of the distance traveled by the plasma flow 42 with respect to the surface to be exposed, over a predetermined duration taken to travel this distance, in this particular case 30 s. The movement of the flow with respect to the element R may be straight or curved or a mixture of the two. In this particular case, the plasma flow has a boustrophedonical movement with respect to the element R so as to expose the whole of the surface S1.

Preferably, the mean velocity V and the distance D are such that V≦−5·D+110, D being expressed in mm and V in m·min⁻¹. These conditions relating to V and D make it possible to improve the efficiency of the method. In order to improve the efficiency of the method, it is possible to vary a very large number of parameters other than the velocity V and the distance D, for example the plasma cycle time (PCT), the nature of the gas or else the pulse frequency of the plasma torch.

Here, D=6 mm and V=70 m·min⁻¹.

Next, during a step 200, the surface S2 is exposed to a flow of a plasma generated by means of the device 22b in a similar way to step 100.

Then, in a step 300, after the steps 100 and 200, the reinforcing element R, here each surface S1, S2, is coated with the adhesive from the bath 28. Preferably, the reinforcing element R treated in steps 100 and 200 is coated directly with the adhesive.

Other subsequent steps which are not represented may also be carried out. By way of example, it would be possible to carry out a draining step (for example by blowing, calibrating) in order to remove the excess adhesive; then a drying step for example by passing through an oven (for example for 30 s at 180° C.) and finally a heat treatment step (for example for 30 s at 230° C.).

The person skilled in the art will easily understand that the definitive adhesion between the reinforcing element R and the rubber matrix in which it is embedded is provided definitively during the final curing of the tyre of the invention.

Comparative Tests

Preparation of the Test Specimens

Test specimens comprising reinforcing elements in accordance and not in accordance with the invention were compared.

Use was made, as reinforcing element, of a PET film sold under the name “Mylar A190” by DuPont Teijin Films and having a degree of crystallinity equal to 38% and an atomic percentage of oxygen element equal to 26%.

The test gum used for the various plies and the rubber matrix in contact with the reinforcing element comprises one or more diene elastomers, here natural rubber, carbon black, a plasticizing oil, a tackifying resin, N-(1,3-dimethylbutyl)-N′-phenyl-p-phenylenediamine (6-PPD), stearic acid, N-cyclohexyl-2-benzothiazyl sulphenamide (CBS) and soluble sulphur.

Each test specimen comprises, in this order, a test ply, a test woven fabric, a test rubber matrix and the PET film in accordance or not with the invention.

The test ply is obtained from two strips of gum made from the test gum described above, inserted between which is a twill nylon textile woven fabric adhesively coated with a conventional RFL adhesive, as described in DE4439031 for example. The nylon textile woven fabric is sold by Milliken under the reference Milliken Europe-Nylon twill-Z19, Cloth-N-094/1-72-N-094/1-72.

The test textile woven fabric is a nylon woven fabric 140/2 250/250 adhesively coated with a conventional RFL adhesive, as described in DE4439031 for example, and having a yarn density equal to 98 y/dm.

The following are placed in a mould, in this order, the test ply, the test woven fabric, the test rubber matrix and the PET film. The test specimen is assembled so that the surface of the PET optionally exposed to the plasma is in contact with the test rubber matrix. A strip of Milar is inserted, over one edge of the test specimen, between the test rubber matrix and the PET film so as to create a peel initiator.

Each test specimen is cured in a press at a temperature of 160° C. for 15 min under a pressure of 1.5 bar. After curing, each test specimen is cooled for 10 min.

Implementation of Peel Tests

The peel test is carried out in accordance with the standard ASTM D-4393-98. The PET film is thus gradually removed from the rest of the test specimen at a constant cross speed of 100 mm/min.

A score representative of the peel appearance is then attributed in accordance with Table 1 below. Thus, the better the adhesion, the less the film is stripped (the more it is covered with gum), and the higher the appearance score.

TABLE 1

| Appearance | Mean degree of stripping of the treated |
|---|---|
| score | film as % of the surface of the film |
| 0 | 96-100 |
| 1 | 81-95 |
| 2 | 61-80 |
| 3 | 41-60 |
| 4 | 21-40 |
| 5 | 0-20 |

First Comparative Test

In a first comparative test, a test specimen (test specimen A) comprising a PET film coated with an adhesion primer and with an RFL adhesive and a test specimen (test specimen B) comprising a PET film coated solely with the RFL adhesive without an adhesion primer are compared. In each test specimen A and B not in accordance with the invention, Ti=Tc=38% and Pi=Pc=26%.

The primer comprises water, 49% sodium hydroxide, polyglycerol polyglycidyl ether sold under the name “DENACOL EX-512” by Nagase Chemicals and a surfactant, here sodium dioctyl sulphosuccinate as a 5% solution in water sold under the name “AOT” by Cyanamid.

The RFL adhesive is as described above.

In this first test, the PET film is coated with the adhesion primer and with the RFL adhesive (test specimen A) or solely with the RFL adhesive without an adhesion primer (test specimen B). Each film is removed from the corresponding bath after a few seconds and is, after each bath, hung by means of a flat clamp over its width in an oven at 215° C. for 2 min 20 seconds.

Test specimen A has an appearance score equal to 5 while test specimen B has an appearance score equal to 0. The layer of adhesion primer is therefore necessary for the good adhesion between the reinforcing element R and the test gum mass of the test specimen.

Second Comparative Test

In a second comparative test, several test specimens prepared using a PET film, the surfaces of which were exposed to a plasma torch or a dielectric barrier discharge (DBD) device, were compared.

The DBD device comprises two electrodes covered with a dielectric material so as to form uniform luminescent discharges. The power delivered in the plasma flow generated by the DBD device, of the order of a few watts (P=U·I·cos φ with U=20 kV and I=1 mA), is around 100 times weaker than that delivered in the plasma flow generated by the plasma torch. The PET film is deposited on a glass plate that can move with respect to an electrode at a maximum speed of 0.18 m/min. The temperature of the plasma flow remains close to ambient temperature.

The plasma torch is sold by Plasmatreat GmbH and the atmospheric plasma flow is obtained from a gas comprising at least one oxidizing component, here a mixture of air and nitrogen.

The atomic percentage Pc of oxygen element of the surface layer is determined by XPS analysis in accordance with the procedure described above. The results are collated in Table 2 below.

TABLE 2

| | Untreated | | | | |
|---|---|---|---|---|---|
| Conditions | PET | 1 | 2 | 3 | 4 |
| Device used | / | Plasma | Plasma | DBD | DBD |
| | | torch | torch | | |
| Gas | / | Air/N2 | Air/N2 | Air | N2 |
| | | (70/30) | (70/30) | | |
| Pc (%) | 26 | 31 | 32 | 31 | 33 |
| Pi (%) | 26 | 26 | 26 | 26 | 26 |
| Pi/Pc | 1 | 0.84 | 0.81 | 0.84 | 0.84 |
| Appearance | 0 | 5 | 5 | 0 | 0 |
| score | | | | | |

The degree of crystallinity Tc of the surface layer is determined by infrared spectroscopy, in particular by ATR infrared spectroscopy, in accordance with the procedure described above. The results are collated in table 3 below.

TABLE 3

| | Untreated | | | | |
|---|---|---|---|---|---|
| Conditions | PET | 1 | 2 | 3 | 4 |
| Device used | / | Plasma | Plasma | DBD | DBD |
| | | torch | torch | | |
| Gas | / | Air/N2 | Air/N2 | Air | N2 |
| | | (70/30) | (70/30) | | |
| I1/I2 | 107 | 57.6 | 59.1 | 101.4 | 104.2 |
| Tc (%) | 38 | 20 | 21 | 36 | 37 |
| Ti (%) | 38 | 38 | 38 | 38 | 38 |
| Ti/Tc | 1 | 1.90 | 1.81 | 1.06 | 1.03 |
| Appearance | 0 | 5 | 5 | 0 | 0 |
| score | | | | | |

It is deduced from these results that only a surface layer having a percentage Pc of oxygen element that is relatively high, that is to say for which Pi/Pc<1, and a degree of crystallinity Tc that is relatively low, that is to say for which Ti/Tc≧1.1, favours the adhesion of the reinforcing element to the test rubber matrix. Under conditions 3 and 4, a surface layer is obtained that does not have a low enough degree of crystallinity to adhere correctly to the test rubber matrix although it does have an atomic percentage of oxygen element Pc greater than that of the internal layer (or of an element entirely made of a material identical to that of the internal layer).

Third Comparative Test

In a third comparative test, a test specimen (test specimen I) comprising a PET film having a degree of amorphization of 100% and that is coated with an adhesion primer and with an RFL adhesive and a test specimen (test specimen II) comprising a PET film having a degree of amorphization of 100% and that is coated solely with the RFL adhesive without an adhesion primer are compared.

After the peel test, test specimen I has an appearance score equal to 5 while test specimen II has an appearance score equal to 0. Thus, the amorphization, even total amorphization, of the surface layer is not sufficient to enable good adhesion between the reinforcing element and the test rubber matrix.

Conclusion of the Comparative Tests

Thus, a low degree of crystallinity or a high percentage of oxygen element is not sufficient to permit good adhesion between the reinforcing element and the rubber matrix and therefore to permit the elimination of the adhesion primer. However, the combination of a relatively low degree of crystallinity and a relatively high atomic percentage of oxygen element permits excellent adhesion between the reinforcing element and the rubber matrix and therefore enables the adhesion primer to be eliminated.

The invention is not limited to the embodiments described above.

It will be noted that in order to measure the degree of crystallinity Ti and the atomic percentage of oxygen element Pi in the internal layer, it is possible, in the case where the chemical and physical modification of the surface layer originates from a surface treatment, to measure this degree and this percentage on a reinforcing element not subjected to this surface treatment, that is to say on an element entirely made of a material identical to that of the internal layer.

Provision may be made to carry out the invention with a multifilament fibre, a monofilament or else a woven fabric of these fibres.

In the case of a multifilament fibre, the surface layer comprises one or more monofilaments, this or these monofilaments being those that are outermost with respect to the internal monofilaments that form the internal layer.

In the case of a woven fabric, it is possible to assemble the latter from fibres treated according to the invention subsequent to the step of exposing the fibres to the plasma flow. As a variant, it is possible to assemble the woven fabric from fibres that are not plasma-treated. The woven fabric comprising the assembled fibres is exposed to the plasma flow.

It could also be envisaged for the multifilament fibre, the woven fabric of fibres, the film or the monofilament to comprise a first portion made of polyester and a second portion made of a material different from that of the first portion. For example, use could be made of a folded yarn comprising a first overtwisted yarn of one or more multifilament fibres made of polyester and a second overtwisted yarn of one or more multifilament fibres made of aramid or made of a polyester of a different nature to that of the first overtwisted yarn.

More than two devices for generating plasma flow, for example four devices, could be provided so as, especially in the case of a multifilament fibre, to treat the entire circumference of the fibre. As a variant, a single device for generating plasma flow could be provided that is movably mounted about a circular path around the direction of movement of the fibre.

Provision could also be made to rotate the fibre upon itself between two flow-generating devices arranged so as to expose two different circumferential portions of the fibre to each plasma flow.

In the case of a film, provision could also be made to simultaneously expose the two surfaces of the film or else to only expose a single surface of the film.

The features of the various embodiments and variants described or envisaged above could also be combined on condition that they are compatible with one another.

1-17. (canceled)

18. A reinforcing element comprising:
a surface layer having a degree of crystallinity, Tc, and an atomic percentage of elemental oxygen, Pc; and
an internal layer having a degree of crystallinity, Ti, and an atomic percentage of elemental oxygen, Pi,
wherein relationships of Ti/Tc≧1.10 and Pi/Pc<1 are satisfied by the surface layer and the internal layer, and
wherein the surface layer and the internal layer are made of polyester.

19. The reinforcing element according to claim 18, wherein Ti/Tc≧1.20.

20. The reinforcing element according to claim 18, wherein Ti/Tc≧1.45.

21. The reinforcing element according to claim 18, wherein Ti/Tc≧1.60.

22. The reinforcing element according to claim 18, wherein Ti/Tc≧1.80.

23. The reinforcing element according to claim 18, wherein Pi/Pc≦0.95.

24. The reinforcing element according to claim 18, wherein Pi/Pc≦0.85.

25. The reinforcing element according to claim 18, wherein Pi/Pc≦0.75.

26. The reinforcing element according to claim 18, wherein a thickness of the surface layer is greater than or equal to 0.5 μm.

27. The reinforcing element according to claim 18, wherein a thickness of the surface layer is greater than or equal to 1 μm.

28. The reinforcing element according to claim 18, wherein a thickness of the surface layer is greater than or equal to 1.5 μm.

29. The reinforcing element according to claim 18, wherein Tc≦30%.

30. The reinforcing element according to claim 18, wherein Pc≧27%.

31. The reinforcing element according to claim 18, wherein Ti≦50%.

32. The reinforcing element according to claim 18, wherein Pi≦27%.

33. The reinforcing element according to claim 18, further comprising at least one element selected from: a multifilament fibre, a woven fabric of fibres, a film, and a monofilament.

34. The reinforcing element according to claim 33, wherein an entirety of the at least one element is made of a material selected from: polyethylene terephthalate and polyethylene naphthalate, with polyethylene terephthalate being preferable for the entirety of the at least one element.

35. The reinforcing element according to claim 33, wherein the at least one element includes a first portion made of polyester and a second portion made of a material different from that of the first portion.

36. The reinforcing element according to claim 18, further comprising a layer of adhesive that directly coats the surface layer.

37. The reinforcing element according to claim 36, wherein the adhesive is a thermosetting type of adhesive.

38. The reinforcing element according to claim 36, wherein the adhesive includes at least one diene elastomer.

39. The reinforcing element according to claim 37, wherein the adhesive includes at least one diene elastomer.

40. A reinforcing ply comprising:
a rubber matrix; and
at least one reinforcing element embedded in the rubber matrix,
wherein each of the at least one reinforcing element includes:
a surface layer having a degree of crystallinity, Tc, and an atomic percentage of elemental oxygen, Pc, and
an internal layer having a degree of crystallinity, Ti, and an atomic percentage of elemental oxygen, Pi,
wherein relationships of Ti/Tc≧1.10 and Pi/Pc<1 are satisfied by the surface layer and the internal layer, and
wherein the surface layer and the internal layer are made of polyester.

41. A finished rubber article comprising at least one reinforcing element,
wherein each of the at least one reinforcing element includes:
a surface layer having a degree of crystallinity, Tc, and an atomic percentage of elemental oxygen, Pc, and
an internal layer having a degree of crystallinity, Ti, and an atomic percentage of elemental oxygen, Pi,
wherein relationships of Ti/Tc≧1.10 and Pi/Pc<1 are satisfied by the surface layer and the internal layer, and
wherein the surface layer and the internal layer are made of polyester.

42. The finished rubber article according to claim 41, wherein the finished rubber article is a tyre.
